(19) United States
(12) Patent Application Publication
(10) Pub. No.: US 2016/0321712 A1
(43) Pub. Date: Nov. 3, 2016

(54) Crowd Sourced Networked Target Feedback

(71) Applicant: Wadju Inc., Los Angeles, CA (US)

(72) Inventor: Theodore SCHIPPER, Los Angeles, CA (US)

(21) Appl. No.: 15/144,661

(22) Filed: May 2, 2016

Related U.S. Application Data
(60) Provisional application No. 62/156,050, filed on May 1, 2015.

(51) Int. Cl. G06Q 30/02; H04W 4/02; G06Q 50/00; G06F 3/0484; G06Q 50/12; G06F 3/0481; G06F 3/0488; H04L 29/08; G06F 17/30

(52) U.S. Cl. CPC G06Q 30/0282; H04L 67/22; H04L 67/18; H04L 67/104; H04W 4/023; G06Q 50/01; G06F 17/30241; G06F 17/3087; G06Q 50/12; G06F 3/04817; G06F 3/04883; G06F 3/04842

(57) ABSTRACT

The present invention generally relates to systems and method for networked computer systems to collect and disseminate data to and from various individuals on a variety of topics as provided by said users while leveraging capabilities of a portable computer processing system such as, but not limited, to a handheld mobile device. The system may leverage widely available mobile device capabilities to collect and correlate data for compilation and presentation amongst users. In addition to data collected and intelligently synchronized from mobile devices in the field, the system may provide access to the mobile devices to review the correlated and compiled information from the whole set of users or specific subsets thereof via a social graph. As data is uploaded to the main server from the mobile devices, it may be made available to other users for comparison, evaluation and rating, among other things.

### CROSS REFERENCE

This application claims priority to U.S. Provisional application 62/156,050 filed on 1 May 2015 titled “Crowd Sourced Networked Target Feedback” which is hereby incorporated by reference in its entirety.

### TECHNICAL FIELD

This application relates to the field of computer networking and peer-to-peer social recommendations as stored, compared, registered, sorted and provided over the internet and through mobile technology.

### BACKGROUND

The proliferation of the internet and mobile technology has facilitated the interchange of thoughts, opinions and reviews on wide range topics, essentially everything and anything. However, there is no restriction on the collection and amassing of commentary thus leading to an effusive amount of information available on any selected topic. An individual seeking to find information, recommendations or commentary from specific groups of reviewers or associates must navigate a wide expanse of information to assemble a summary of the required information. Further, as the primary focus of attention, within the public food sector, on perusal of available information, an individual may find short to lengthy reviews of restaurants on a myriad of aspects of the selected operation however, it is extremely difficult, if not unavailable, to find recommendations of specific menu items. These specific opinions, if found, are presented as individual thoughts, with no specified order and frequently from unknown sources and the desire for some form of orderly presentation or selective presentation remains unavailable.

### SUMMARY

Systems and methods for networked collaboration, are disclosed including non-transitory computer-readable storage medium, systems and methods for sending, from a mobile device in communication with a network and server over the network, login credentials from a first user, sending GPS geographic coordinates of the mobile device to the server over the network, receiving target information over the network, based on the geographic coordinates, causing display of a subset of the target information, causing display of a rating option of the target, receiving a rating selection of the target, sending the rating selection of the target to the server over the network, and receiving a compiled rating of the target from the server over the network. Some examples include the display of the rating option of the target includes at least one icon, the at least one icon display size is based on the received rating selection for the target. Some examples include the received rating selection for the target rating is a touch screen swipe. And some examples have the icon display size is based on the number touch screen swipes received. In some examples, the icon is a heart and in some the icon is a circle with a bar through it. Some examples may have displays of an identity of a user who contributed to the rating of the target. And in some examples, the target information includes location information of the target. In some examples, the systems and methods include causing display of a map including an indication of the target location and an indication of the mobile device location, and causing display of a distance information between the target location and the mobile device location. In some examples, the target is a restaurant and the target information includes restaurant information.

Additionally or alternatively, some example systems and methods may include using a server in communication with a database and a network, the server configured to, receive a login credential of a first user from a first mobile device over the network, receive geographic coordinates from a GPS of the first mobile device of the first user over the network, send information about a target to the first mobile device of the first user over the network, the target information based on the received geographic coordinates, receive a rating of the target from the first mobile device of the first user over the network, store the received rating of the target from the first mobile device of the first user, receive a login credential of a second user from a second mobile device over the network, receive geographic coordinates from a GPS of the second mobile device of the second user over the network, and send the stored rating of the target to the second mobile device of the second user, if the received geographic coordinates from the second mobile device falls within a range from the target. In some examples, the stored rating of the target, sent to the second mobile device is capable of being displayed as an icon, wherein the size of the displayed icon changes based on the rating. In some examples, the server is further configured to, provide a search capability to the first mobile device, receive a search query from the first mobile device, the search query including target information, send search results of targets based on the search query. In some examples, the search query includes other user rating information. And in some examples, the systems and methods may be used to provide a filter capability to the first mobile device, the filter capability applying to the users submitting the stored ratings, receive a filter criteria from the first mobile device over the network, apply the filter criteria to the stored ratings, and send a filtered set of stored ratings to the first mobile device over the network, the filtered set of stored ratings based on the applied filter criteria. In some examples, the server is further configured to, calculate a distance between the received location of the first mobile device to a known location of the target, and send the distance to the first mobile device, for display on the first mobile device.

### BRIEF DESCRIPTION OF THE DRAWINGS

For a better understanding of the embodiments described in this application, reference should be made to the Detailed Description below, in conjunction with the following drawings in which like reference numerals refer to corresponding parts throughout the figures.

FIG. 1 is a diagram depicting an example computer network which may be used in implementing the embodiments described herein.

FIG. 2 is a flow chart describing one example method to implement the inventions described here.

FIG. 3A is an example GUI showing geographic locations of targets, according to certain embodiments herein.

FIG. 3B is an example GUI showing target information, according to certain embodiments herein.

FIG. 3C is another example GUI showing target information, according to certain embodiments herein.

FIG. 4 is an example GUI showing geographic locations of targets on a map, according to certain embodiments herein.

FIG. 5 is another example GUI showing geographic locations of targets on a map, according to certain embodiments herein.

FIG. 6 is an example GUI showing ratings of targets, according to certain embodiments herein.

FIG. 7 is another example GUI showing geographic locations of targets, according to certain embodiments herein.

FIG. 8 is an example GUI showing item detail, according to certain embodiments herein.

FIG. 9 is another example GUI showing item detail, according to certain embodiments herein.

FIG. 10 is an example GUI showing item detail, according to certain embodiments herein.

FIG. 11 is an example GUI showing recommendation list, according to certain embodiments herein.

FIG. 12 is another example GUI showing recommendation list, according to certain embodiments herein.

FIG. 13 is an example GUI showing category list, according to certain embodiments herein.

FIG. 14 is an example GUI showing think page, according to certain embodiments herein.

FIG. 15 is an example GUI showing Comments Listing, according to certain embodiments herein.

FIG. 16 is an example GUI showing Select/Invite, according to certain embodiments herein.

FIG. 17 is another example GUI showing Select/Invite, according to certain embodiments herein.

FIG. 18 is an example GUI showing Selection Mode, according to certain embodiments herein.

FIG. 19 is an example GUI showing Filters, according to certain embodiments herein.

FIG. 20 is an example GUI showing Profiles settings, according to certain embodiments herein.

FIG. 21 is an example GUI showing Manage Groups, according to certain embodiments herein.

FIG. 22 is an example computer diagram which may be used to practice the methods and disclosures discussed here according to certain embodiments herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

### Overview

The present invention generally relates to systems and method for networked computer systems to collect and disseminate data to and from various individuals on a variety of topics as provided by said users while leveraging capabilities of a portable computer processing system such as, but not limited, to a handheld mobile device. Example embodiments may take into account both wirelessly connected and disconnected environments integrating connection detection for intelligent synchronization to a server based software service. The system may leverage widely available mobile device capabilities including smart phone/tablet cameras, GPS chipsets, LED lights, etc. to collect and correlate data for compilation and presentation amongst users. In addition to data collected and intelligently synchronized from mobile devices in the field, the system may provide access to the mobile devices to review the correlated and compiled information from the whole set of users or specific subsets thereof via a social graph. For example, the data reviewed may be that collected from a user's private dietary club. As data is uploaded to the main server from the mobile devices, it may be made available to other users for comparison, evaluation and rating, among other things.

It is this dissemination of information to mobile devices of member users who are in various places that makes the restaurant information practical and relevant to each member user. Instead of researching at home which restaurant to go to, or waiting to rate a restaurant, the system may be used by mobile devices to access in real time only relevant restaurants, and allow member users to rate them while at the restaurant itself.

It should be noted that the embodiments described here may relate to restaurants and food dishes served at restaurants. These descriptions are not intended to be limiting in any way but merely exemplary. Instead, any type of target may be used instead of restaurants including but not limited to retail shops, movie theaters, grocery stores, coffee shops, or any other enterprise selling goods and/or services to customers. Further examples may include home entertainment feature films, television shows, beauty products, vacation destinations, wines, all variations of clothing and shoes. The examples using restaurants and food here could be substituted for any other target.

### Example Network Embodiments

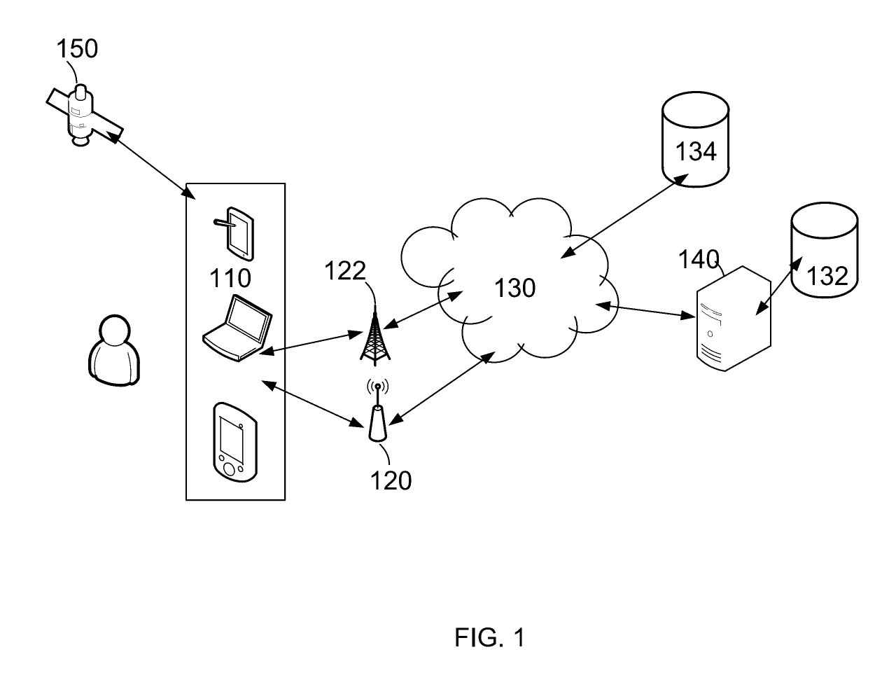

FIG. 1 shows an example embodiment of a network which may be used to allow communication among the various user devices 110 and the systems described here. For example, the user devices 110 could be any kind of mobile device such as, but not limited to cell phones, smart phones, tablets, phablets, laptops, automobiles, glasses, watches, or any other mobile device able to communicate over a wireless connection 120, 122 with a network 130, such as the Internet. The wireless connection 120, 122 between the user devices 110 and network 130 could be any number or wireless connections 120, 122 including but not limited to cellular 122, WiFi 120 (802.11 standard), pico cell, femto cell, or any other wireless connection.

The user devices 110 may include the ability to communicate with a geographic positioning system (GPS) satellite 150 or other cell tower triangulation or other location device. The system may include any number of server computers 140 also in communication with the network 130 or Internet and also digital storage systems 132 such as databases 132 either over the network 130 such as referred to as in the cloud 134 or locally 132.

Any number of user devices 110 could be used to log into the system 140 and interact with the system 140 and other users via their respective devices 110. Signals containing data may be sent from the system 140 to the individual user mobile devices 110 to update the target information and location information.

Certain example embodiments may employ an application which may run on the mobile user device 110 with a computer operating system which allows the user to both provide and retrieve data from a computerized database 140 of specific target information including but not limited to restaurant dish recommendations within restaurants at large. The application may allow an individual to also store his/her own list recommendations for reference, review and sharing. Further, such systems could be used to retrieve, collate and present data relating to user restaurant recommendations from a remote server and an input interface for the device user.

### Mobile Device Interaction Examples

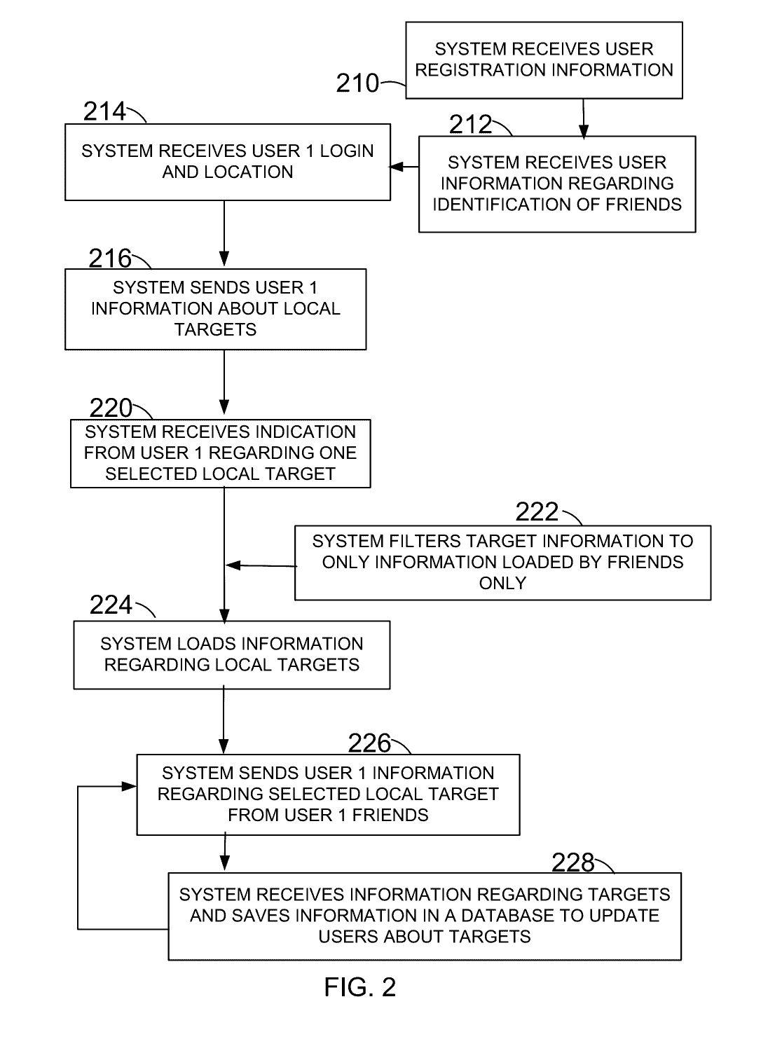

To help illustrate these examples, explanation of a use scenario in FIG. 2 shows an example embodiment of a flow chart showing how the system may flow.

At some time, the system may receive registration information from a user 210 regarding preferences, including identification of friends who are also registered on the system. 212

At some other time, for example, a user may login with a mobile device, and identification of the location of the mobile device to the system 214. Next, 216 the system may send the user target information for the location they have identified. Next, 220 the system receives an indication from the user regarding a selected local target. In certain embodiments, the target information is filtered by the list of user identified friends 222. In other words, the system only sends information that the user's friends have loaded about that target.

Then the system can load information 224 regarding local targets from and connect with selected other users. In such a way, the individual user may be able to retrieve information provided by the system about relevant and local targets as well as information that selected users have uploaded about those local targets.

The system can then send the user information regarding the local targets 226, but only using information loaded by the user's identified friends. The system can also then receive information about the targets and update any users as to the new information 228.

In certain example embodiments, the flow chart depicted in FIG. 2 and the methods described herein may be conducted via an application on a user's mobile device. Such applications may be downloaded to the device and the user interface (UI) launched. Upon such launch, the application may initially identify itself and the brand name along with any of various advertisements. Once opened, there may be immediate functionalities that could be available to the user.

In accordance with some examples of the invention, the application uses some type of location system such as a Global Positioning System (GPS) to identify the location of the device in order to provide the user with a list of restaurants in the immediate vicinity of the user. The general user can review the information provided by all members of the application and can utilize the application to search for restaurants, member names and their proprietary recommendation pages as well as particular food items.

It should be noted that GPS is not the only way that the system may be able to locate itself when employed on a mobile device. Cellular towers with which the mobile device communicates with may provide location information. Triangulation by the mobile device among more than one cellular tower may be used as well. Certain embodiments may employ location determinations based on short range communications such as WiFi as well. Any of various satellite (GPS) radio (cellular, WiFi) etc. may be used. This location information may then be fed into the system in order to narrow the scope of information for each user to only that information that is relevant to them based on geographic position and relative proximity to target restaurant. In other words, the system may use the location information to populate maps for each user's mobile device, with restaurant data and corresponding menu data as well as member user feedback regarding those restaurants.

### Membership Examples

Certain example embodiments to the systems and methods here may include allowing users to register with the system or create an account as members. By uploading certain information about themselves, users can select a username and login in order to indicate and authenticate themselves on the system. Further, such an account may allow for the user to customize the interfaces, select friends as members of groups and narrow the recommendations of a target, as described below.

By so creating an account, the system may be able to customize services for the individual users. The system may be able to connect users with other users with whom they identify. For example, a member can login to a website on a computer to review the member's personal recommendations page, view other member's pages, search information and review item recommendations. Without the registration of a particular user, the system may not be able to load a list of identified friends to filter the target information. Instead, such non-registered users may have the ability to see all user target information, but not filtered information.

### Social Network Examples

Regarding the ability for the system to allow users to indicate one another as friends or trusted members, etc. the system may be arranged to store such information in database or cloud storage. By members indicating that other members are friends/ trusted members, a social graph may be built of first, second and third degree friends. Such information could be used in supplying members with ratings of targets and details of targets which were uploaded by only friends, or only friends of friends, etc. according to the social graph. Such a social graph may also be used to find new user friends and connect via the system.

Such features may be relevant to users because they may trust their social network more than random strangers for recommendations. This can be especially true for other rating sites that allow any person to write a review. Often these reviews are populated by restaurant owners themselves in order to inflate their status online. But as has been demonstrated with social networks in other arenas, the social pressure to voice accurate and realistic reviews to friends in a non-anonymous way can result in more accurate reviews and more trustworthy data. In other words, anonymous users are not held accountable for their uploads.

Further, social networks may be tapped in order for recommendations to be vetted by users. For example, if one friend is known to have good taste by her peers, her reviews may be taken with more weight than another friend who will eat anything. Within social circles, these reputations are known and can be leveraged by the users in making decisions.

### Geographic Location

As discussed above in FIG. 1, the system may utilize GPS location information in order to customize the information to send to any particular user. In such a way, the user's device may be sent only relevant target information, based on location, instead of targets which are far from the user, physically. In certain embodiments, the system is able to take and process the GPS location information to also list the nearby targets, map the nearby targets and customize the information sent to any particular user.

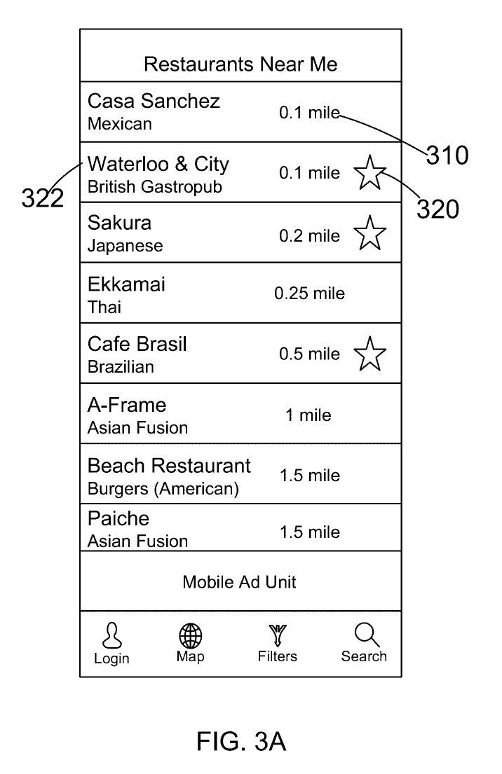

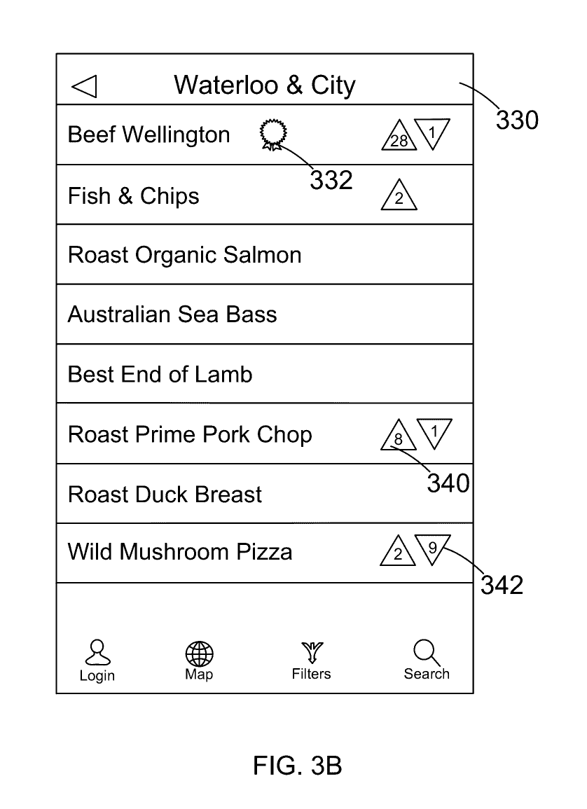

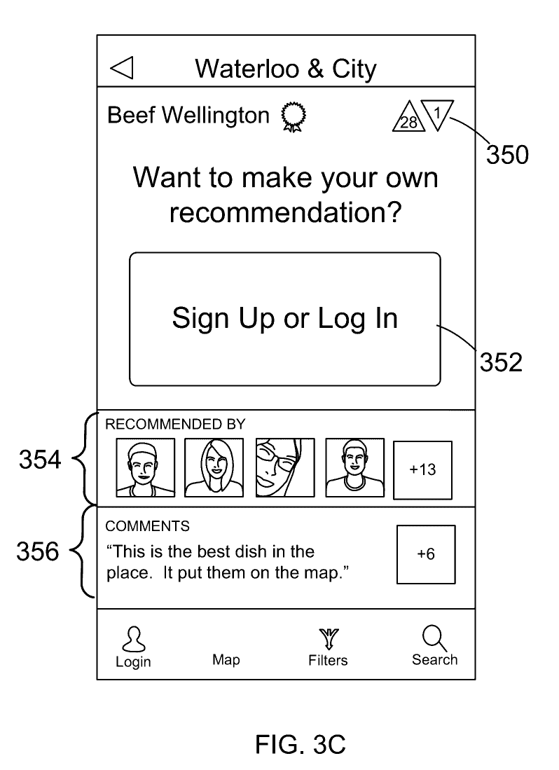

FIG. 3A shows an example GUI depicting restaurants near the location of the user. Certain example embodiments, the application uses information sent from the mobile devices' Global Positioning System (GPS) to inform the system of the location of the device in order to provide the user with a list of restaurants and their distances 310 in the immediate vicinity. Certain examples may also use symbols 320 alongside said listed names 322, as applicable, designed to indicate that a particular target has been visited and experienced by a particular Member and a recommendation for an individual detail about the target. For example if the target is a restaurant, the detail may be a culinary theme or signature dish that has been registered and stored in the database.

In certain embodiments, the member may see a variation of the symbol 320 alongside said listed names, as applicable, designed to indicate that a particular target has been frequented by a friend of said Member and a recommendation by a friend for an individual dish has been registered and stored in the database. Thirdly, another marker will be applied to qualified listed restaurants to indicate that the restaurant marked offers within it a very numerously positively recommended “signature dish”.

Still discussing FIG. 3A, in some embodiments, tapping or clicking a restaurant name 322 may reveal a page or window with information for the user. Such information could be a menu, coupons, deals, promotions, or any combination of these.

Still discussing FIG. 3A, targets are listed by name in an order based on proximity to the user. Further, a unique designation may appear beside a target indicating that a recommendation exists for that target. For general users, those who are not members of the application all designation will be the same color. For members of the application, the color of the designation will indicate whether the existing recommendation is from any general member of the application or from a member of the application who is a friend of the user. In addition, there may be an additional icon beside a target indicating that within the target is an item of exceptional/special rating (ex. For restaurants a signature dish, for stores a very popular item, for theaters a very popular film)

In accordance with some examples of the invention, the application can allow each member to have a personal recommendations page. This page lists every recommendation provided by the individual member. There will be different pages linked under the same user for different categories of recommendations. A summary page of what categories and how many recommendations per category will be available for each member. As an example, the first page will be a list of all dishes recommended by the member. Tapping on a dish will move the user to the menu page for that particular dish. A further example is a separate page listing every television show recommended by the member. A third example would be a separate page listing every wine recommended by the member.

In accordance with some examples of the invention, the application uses a Global Positioning System (GPS) to identify the location of the device in order to provide the user with an image of a superimposed view of a local map with indicators for restaurants in the immediate vicinity of the user with a drop down menu for said listed names, with a symbol within said dropdown menu designed to indicate that a particular establishment has been frequented by a Member and a recommendation for an individual dish has been registered and stored in the database. Further, a Member may see a variation of the symbol within the dropdown menu, as applicable, designed to indicate that a particular establishment has been frequented by a friend of said Member and a recommendation by a friend for an individual dish has been registered and stored in the database. Thirdly, another marker will be visible, as applicable, within a restaurants dropdown window to indicate that the restaurant offers within it a numerously positively recommended “signature dish”.

FIG. 3B shows an example target page with restaurant menu information in this example. The target is named 330, the menu is shown including indications of “signature dishes” 332 Other things could be indicated such as spice rating of a dish, raw ingredients, gluten free, vegan, vegetarian, or other indicators.

Even visual indicators of positive and negative review by positive 340 and negative 342 icons. The icons could be anything including colored in a way that could indicate positive or negative. Information for menu items can be found by tapping or selecting a menu item as well as information about the review may be found by tapping or selecting the reviews. Reviews can be ordered according to highest rating first or any other way.

FIG. 3C shows an example GUI of a target page when a user is not logged in. The recommendations 350 may be viewed but not entered by the user unless they log in 352. Public users 354 may be seen as well as comments 356. In some embodiments if more than a certain people have recommended the dish, then display a “+n” icon, which, when tapped, takes the user to a RECOMMENDED LIST PAGE. Tapping the comment takes the user to the COMMENTS LIST PAGE. Tapping any of the individual user avatars takes the user to the corresponding Profile page for that user.

### Recommendations Examples

In accordance with some examples of the invention, the application can allow an application member to select a menu item from a selected menu and the member will then see a list of members that have recommended the item, can access a longer list of members if so required, can see detailed commentary and photos provided by members, can access other members personal pages and is provided with the opportunity to recommend the item. The recommendation mechanism as presented in diagram x involves an action taken by the member on the user interface. A swipe up on the screen indicates a positive recommendation and a swipe down indicates a negative recommendation. A positive recommendation is represented by a heart while a negative recommendation is represented by a circle with a bar through it. The member is provided with the option to swipe upwards up to three times indicating the extent of the positive recommendation. A second swipe up indicating a larger positive recommendation and a third swipe up even greater. This increase in affect is reflected by the heart icon growing in size to reflect the greater emphasis. Equally, a negative review can be reinforced up to three times and each swipe down will increase the size of the circle with the bar in it. The scale is fluid such that if a member swipes up three times the heart is at its maximum size, however, if the member then swipes down the heart reduces to the second largest size another swipe down reduces it to the first stage of positive recommendation another swipe down would display a neutral recommendation with next swipe down being the first size of a circle with a bar through it etc. A member can after any action either leave the rating page or press a done button thereby submitting the indicated rating into the data base. A neutral rating will not be submitted to the data base.

### Sharing Examples

In accordance with some examples of the invention, the application can allow a member to set their personal page on private and thereby restrict the access of other members to view it. A member can restrict all other members from accessing the page or provide access to those specific members which said member would permit to view their page. The general member will not be able to view another member's page that has been set to private in which case the member may request access to view said page. The member with the privacy setting can then elect to allow the request or not. If permitted, the requesting member will now have access to that member's page.

In accordance with some examples of the invention, the application can allow a member to view another member's personal page and said page will indicate if the viewed member is within a member's friend list or within a specified group created by the viewing member or allow the viewing member to add the viewed member to his friends groups for easier access to the viewed member's for future review.

In accordance with some examples of the invention, the application can allow members to share their ratings with others through the commonly utilized internet and/or mobile social media outlets.

### Maps of Location Examples

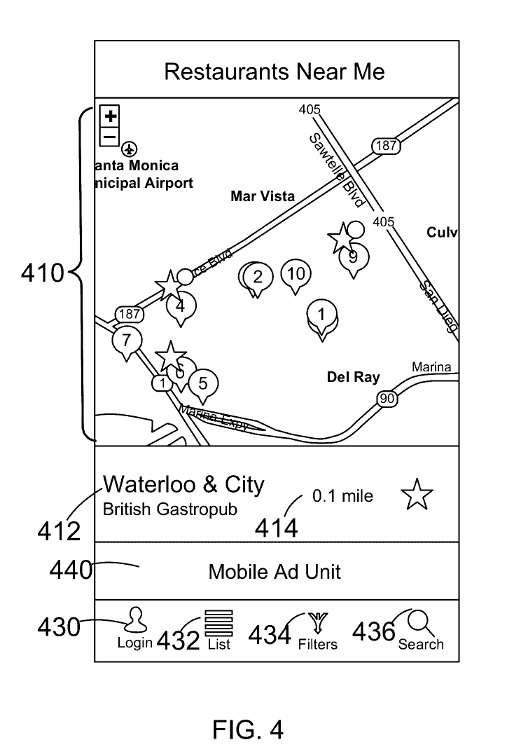

FIG. 4 shows an example embodiment with a map 410 of the vicinity of the user and various targets surrounding the user. As explained above, the geographic location of the user device can inform the system of the location and the system is then able to send the map and target information 412 to the user device for display and manipulation.

Still discussing FIG. 4, targets may be indicated by symbols 420 such as tags over a local map 410 view with users present location indicated. A visual depiction of distance may be provided 414. Each tag may contain a color indicator to represent information as provided in the list view of FIG. 3. If the user is not a member of the application the two color indicators available could be one to indicate a target has a recommendation provided by an application member and one to indicate the target contains an item of exceptional/special rating. In addition, each target tag, if isolated, can drop down and provide specific details about the target. Such details to include the name and descriptive category of the target. Isolating a target will take the user to a specific page with detailed information provided by the target.

In the example of FIG. 4, the user is not logged in but may do so by utilizing the log in button or other ways. 430 The display in FIG. 4 also shows a list 432 of other nearby targets, an option to filter 434 the targets and a search 436 feature. An arrangement is shown with an advertising section as well 440.

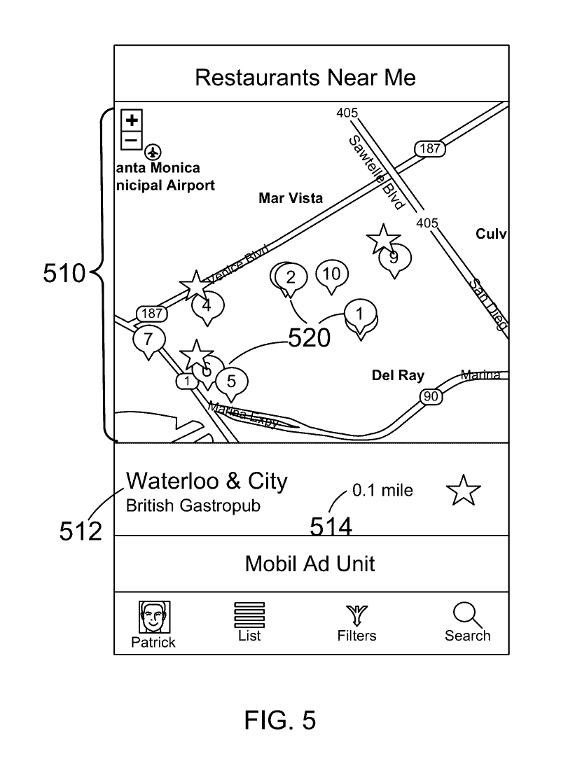

FIG. 5 shows another example map 510 display sent to the user mobile device from the system. In this example embodiment, the user is logged into the system. By logging into the system, the system can inform the user of the recommendations that are updated by the user friend list or group list as described elsewhere herein.

Still discussing FIG. 5, targets 520 are indicated by symbols such as tags over a local map view 510 with users present location indicated. A visual depiction of distance is provided 514 in the example. Each tag 520 may contain a color indicator to represent information as provided in the list view of FIG. 3. If the user is a member of the application the color indicators available would be one to indicate a target contains a recommendation provided by an application member, one to indicate that a target contains a recommendation provided by a member of the application who is a friend of the user and one to indicate the target contains an item of exceptional/special rating. In addition, each target tag, if isolated, can drop down and provide specific details about the target. Such details to include the name and descriptive category of the target. Isolating a target will take the user to a specific page with detailed information provided by the target.

### Search Criteria Examples

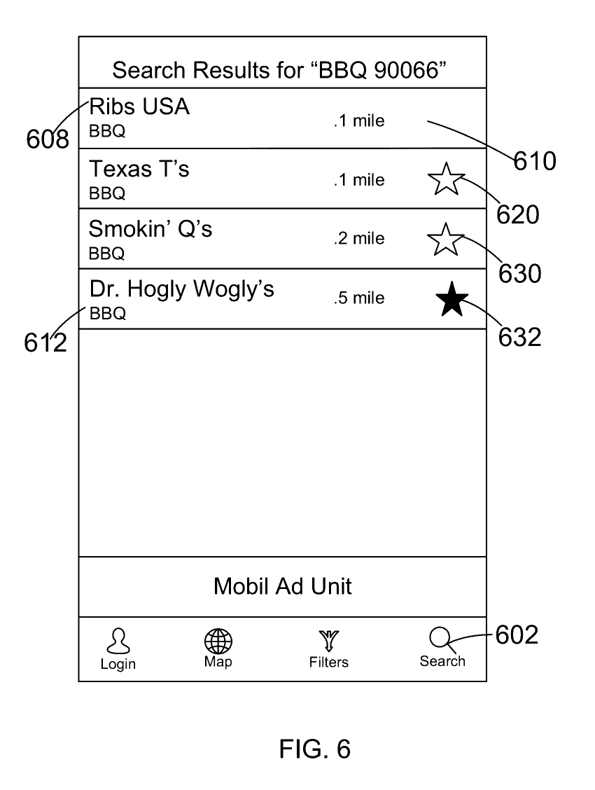

FIG. 6 shows an example search result embodiment. In this example, the user has entered information regarding a specific target that the user wishes to learn more about through the search icon 602. This search criteria is sent to the system by the mobile user device via the network. The system is then able to send back to the user device, search results which are sorted according to particular criteria. For example, the GUI in FIG. 6 shows results sorted by distance from the user. “Ribs USA” 608 is shown as 0.1 miles 610 from the user where “Dr. Hogly Wogly's” 612 is shown as 0.5 miles away. Also, the example shows certain targets with an icon next to them 620. Such icons can be used to indicate which search results have corresponding ratings associated with them. Further, such icons could be used for any number of things such as indicating the highest rated restaurants 630, favorites as indicated by the user's friends 632, etc.

In certain embodiments, the Search functionality may enable a user to search for a restaurant, a particular dish or a member. When searching for a restaurant, the result may appear and the user can be directly taken to the menu of said restaurant by clicking or tapping on the name of the restaurant. When searching for a food, a list of qualifying items will appear. The list will appear in a proximity listing with a dish in the nearest restaurant listed first. A user can then move from the list of searched dishes directly to the menu of the restaurant offering said dish. Searching for a member will provide a list of qualifying members. The user can then go directly to the listed user's personal page to review the recommendations provided by that user.

Still discussing FIG. 6, users may search the application for targets and other members. The results of the search function are displayed in a listed form with the closest proximal target listed on top. Each target listed will have its recommendations listed in icon form alongside so a user can evaluate the target upon viewing. Very specific searches will only return the sole desired response.

### Target Detail and Commentary Examples

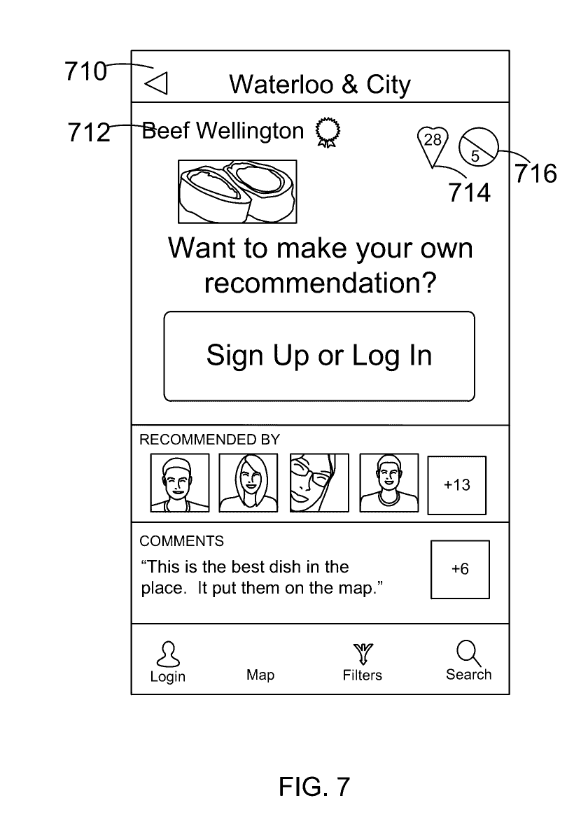

FIG. 7 shows an example target detail page for a user who has not logged in. In this example, the target 710 is a restaurant and the details are menu items. Thus, in accordance with some examples of the invention, the application can allow a user to immediately review the menu 712 of a selected restaurant. The menu as displayed will provide a user with a counter 714, 716 alongside those applicable dishes indicating the number of positive recommendations as well as the number of negative recommendations or any combination of those. The counter 714, 716 is represented through icons representing for positive and negative recommendations. A positive recommendation is represented as a heart 714 and a negative recommendation is represented as a circle with a bar through it 716 in this example but could be any kind of icon, counter, or other indicator. Either of the icons 714, 716, if present alongside a menu item will have a number in them indicating the number of times this type of recommendation has been submitted by a different member. The general user will see the results of all members who have provided data with regard to the viewed menu. A member can filter down the data such that only recommendations from those members the user would like to see are exhibited.

In accordance with some examples of the invention, the application can allow a user to select a menu item 712 from a specific menu page and see a list of members that have provided a recommendation for that item. If required due to an extensive list, a user can access a longer list of members that have recommended that particular dish and from that point can access the personal pages of a user that has recommended the dish. Further, a user, can view any pictures or detailed commentary that a member has submitted for that dish. A user, unless a member, cannot submit their own personal recommendation for that dish.

In accordance with some examples of the invention, the application can allow users to view the commentary page for a dish. The listed comments will include the member's name that submitted the comment. A user can go from the comment to the writer's personal recommendations page. A general user will see all commentaries from all submitting members. A member will be permitted to add a commentary and will have the ability to filter the commentaries down to only those commentaries from members that the member would like to review.

Therefore, upon review, a user can identify the items the number of positive and negative recommendations for each item listed. In addition, if an item has been deemed a specialty or exceptional product then a third icon will be represented indicating to a user that the associated item is something recognized to be exceptional and/or special. For users who are members of the application, they can apply self-created filters over the described item listings and thereby only see recommendations from those users they have isolated to be part of the filter. Therefore, instead of seeing recommendation counts from all members of the application they will only see the applicable recommendations from those members as listed by said member in the applied filter.

It should be noted that the restaurant and menu data which is passed to the users can be procured in any of various ways. In certain embodiments, the menu data is pulled or scraped from third party applications or data storage. Such a procurement may be done via a back end server in order to load into proprietary data storage or to load in real time as such restaurants are accessed. In certain embodiments, the menu data may be procured from user members who upload data. In certain embodiments, the menu data may be uploaded by the restaurant owners. In certain embodiments, the menu data may come from employees of the company who runs the system. Updates to the restaurant and menu data may also occur in any of various ways. Thus, any of various sources may be used for the restaurant and menu data described here.

### Recommendation Examples

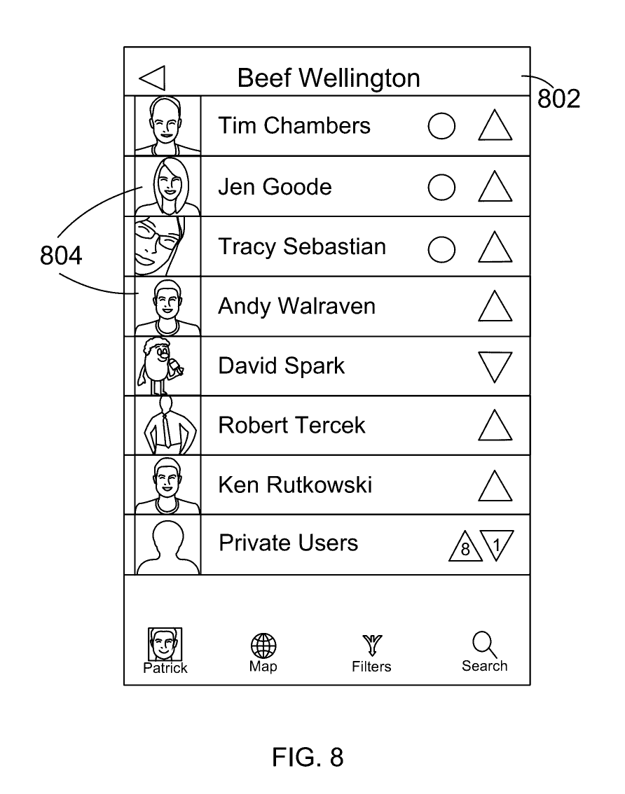

FIG. 8 is an example GUI showing item detail 802, where a selected item is available for members to provide recommendations on. A non-member user, when taken to this GUI, will not be permitted to provide a recommendation but rather will be asked to sign up or join the application as a member. Avatars of the members 804 who have provided recommendations on the item will be listed and any user can select a member's avatar and be taken to that member's personal recommendations page. Lists of any commentaries submitted by members in addition to their recommendation are listed as well and any user can read the provided commentaries. Logged in users may sort this list to see friends of theirs, as indicated in the system and/or social media third party system.

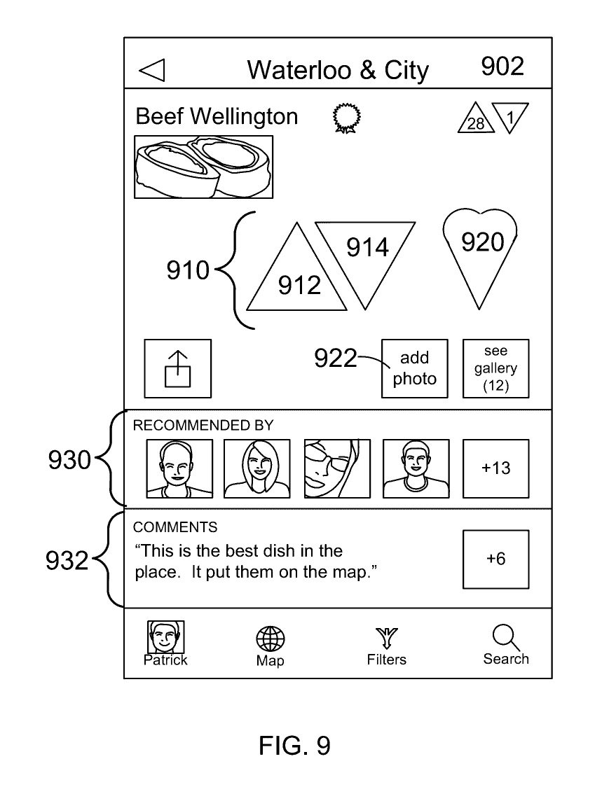

FIG. 9 is another example GUI showing item detail where a selected item 902 is available for members to provide recommendations. A member user, when taken to this GUI, will be permitted to provide a recommendation utilizing the designed rating mechanism 910. A swipe upwards 912 will indicate a positive recommendation and the positive icon will appear 920 on the screen. A swipe down 914 will indicate a negative icon (not shown) and the negative icon will appear on the screen. Members will be given the option to swipe in either direction up to two additional time thereby indicating the fervor of the recommendation. Each additional swipe up will be represented by the icon increasing size. After a third swipe, the icon would be at its maximum size and any further swiping would not register and additional data. Further if a member wished to reverse the recommendation to the opposite spectrum, the member would have to swipe in the opposite direction the number of times already registered to return to neutral and then continue with additional swipes in the changed spectrum. In the event a member has rated the item previously, the member will be shown the previous rating and will be permitted to make a change. The member will also be presented with the option of sharing the new recommendation on several common social media sites. Members will also be presented with the option to submit pictures 922 of the items they are rating in order to have them stored for future review. Avatars of the members 930 who have provided recommendations on the item may be listed and any user can select a member's avatar and be taken to said members personal recommendations page. Lists of any commentaries 932 submitted by members in addition to their recommendation are listed as well and any user can read the provided commentaries. Members will be permitted to enter and submit their own commentary.

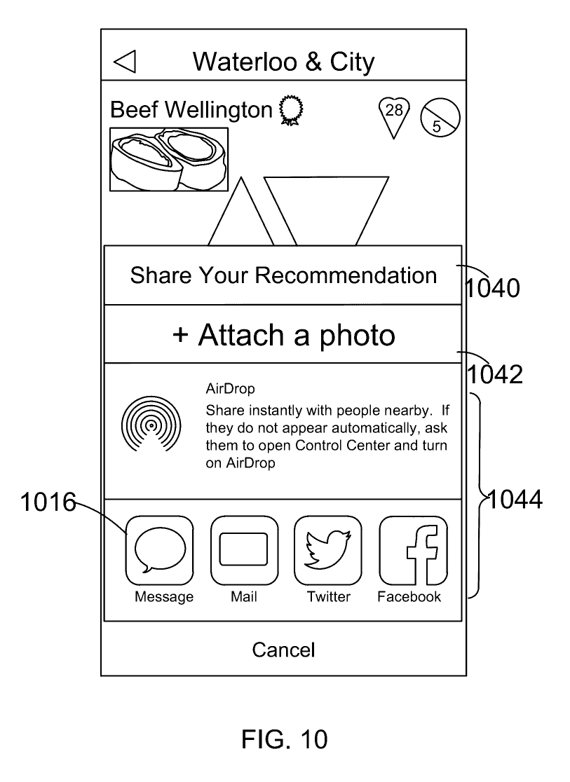

FIG. 10 is an example GUI showing item detail where upon submitting a recommendation, a member will be provided with the option to share the new recommendation on popular social media sites 1044 or have it sent to specified individuals 1016. The member will be given the option to take a photo 1042 and attach it if the member has not already taken and submitted a picture.

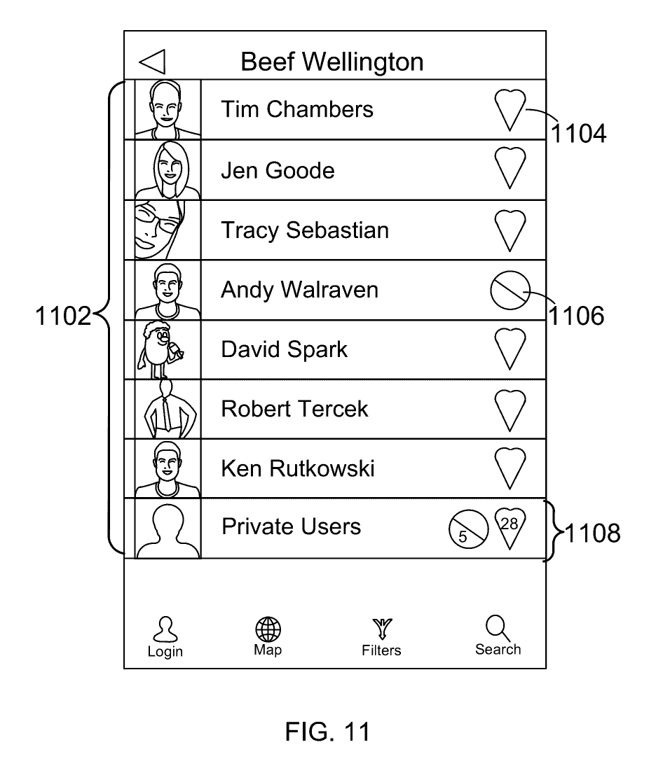

FIG. 11 is an example GUI showing recommendation list, where upon accessing the rating page for an item, a user may choose to view a list of the members 1102 who have provided the aggregated recommendations. In some embodiments, this will appear in a list form in an order determined by the most recent submitted recommendation at the top. The list will name the member and then indicate the recommendation provided by that member. Recommendations are represented by the icons 1104, 1106 one for positive 1104 and different on for negative 1106. In the event a member has elected to remain private, the name of the member will not be listed, however, the cumulative of the recommendations provided by private members will be listed with the positive icon and the aggregate number of positive recommendations displayed within it beside the negative icon and the aggregate number of these recommendations within it 1108.

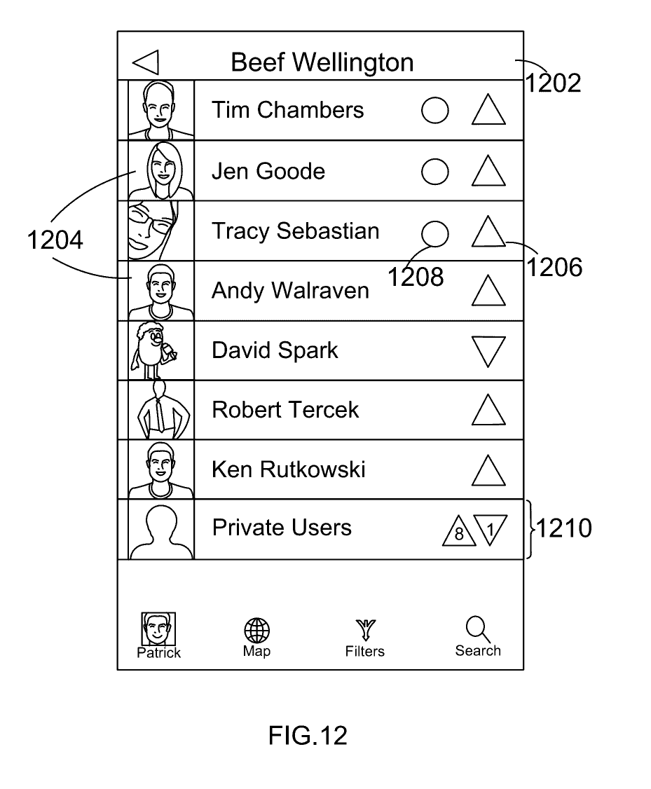

FIG. 12 is another example GUI showing recommendation list, where upon accessing the rating page for an item 1202, a member may choose to view a list of the members who have provided the aggregated recommendations. This will appear in a list form in an order determined with the members with whom the member is familiar listed at the top of the list and arranged by most recent recommendations first followed by the remainder of the members who have provided recommendations unknown to the user listed in an order with the most recent recommendations listed first. The list will name the member 1204 and then indicate the recommendation provided by that member. Recommendations are represented by the icons, one for positive 1206 and different one for negative 1208. The members familiar to the member will be indicated by the icons appearing in a different color consistent for all members who are familiar to the reviewing member. In the event a member has elected to remain private, the name of the member will not be listed, however, the cumulative of the recommendations provided by private members will be listed with the positive icon and the aggregate number of positive recommendations displayed within it beside the negative icon and the aggregate number of these recommendations within it 1210.

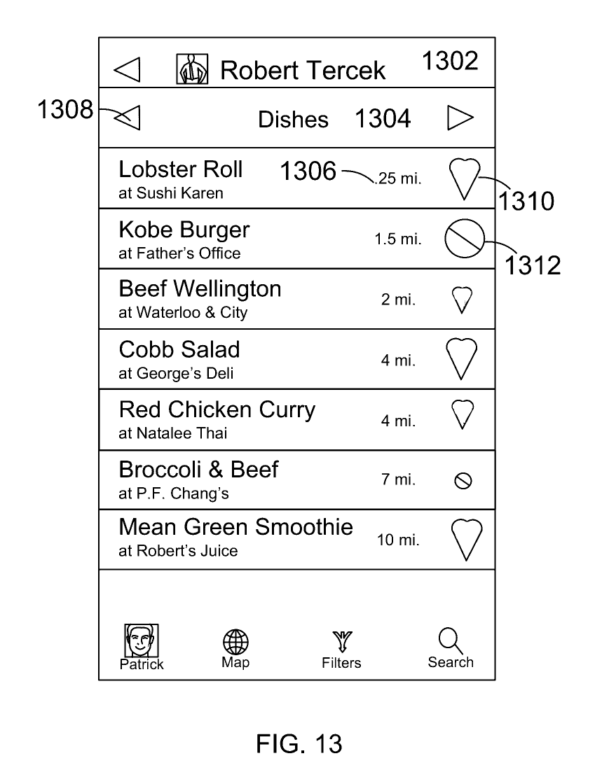

FIG. 13 is an example GUI showing category list 1304, where the personal recommendations page provides a list of all of the recommendations a member 1302 has provided. Recommendations within one category are listed according to proximity of target 1306 which offers the item. A user can move between categories within which the member has made a recommendation by sliding the screen 1308. Each item is listed with the member's recommendation represented by the icons 1310, 1312 one for positive 1310 and different one for negative 1312. The icon representing the recommendation will appear in one of the three sizes indicative of the number of swipes the member submitted upon submitting the recommendation. Therefore a user can immediately determine the emphasis of the recommendation by reviewing the size of the icon for the recommendation.

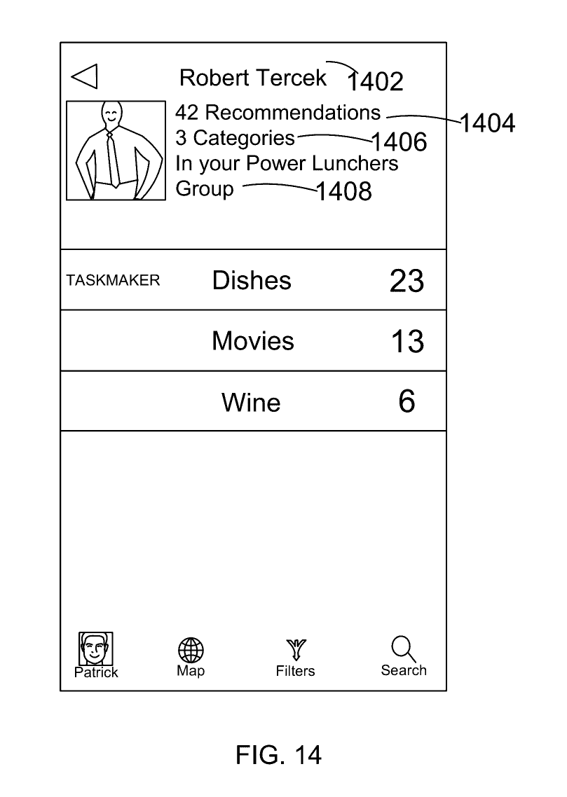

FIG. 14 is an example GUI showing a WADJU think page, where each member 1402 has personal recommendations pages for the items within different categories all of which is summarized in this page. A user can review that a particular member has an indicated number of reviews in each of the listed categories. The categories are listed in alphabetical order. At the top of the page is the member's name 1402, the total number of recommendations 1404 the member has provided across all categories, the number of categories 1406 the member has been active in, an indicator as to whether this member is someone the viewing user, if a member, has identified as someone the viewing user is a familiar with and the label of any subgroups the viewing user, if a member, has selected this member to be included within 1408.

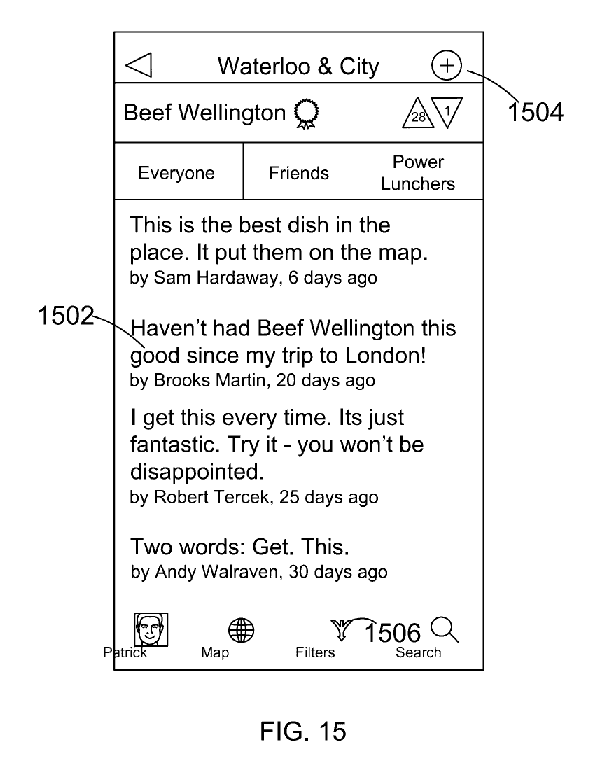

FIG. 15 is an example GUI showing Comments Listing, where upon accessing the comments listing for a particular item, a user can review all of the comments provided by members for said item. A user can move to a particular members personal recommendations page if they so choose. A user who is not a member will be able to read all the comments 1502 but cannot add any new comments of their own. A member user will have the option to add a comment of their own 1504. Further, members will be able to filter the comments 1506 presented to only those by members whom the member is familiar with or to a more refined degree to those comments from members who the member is familiar with and who are members of a select subset the member has created. The member may have multiple subsets of members with whom the member is familiar.

### Selection and Invitation Examples

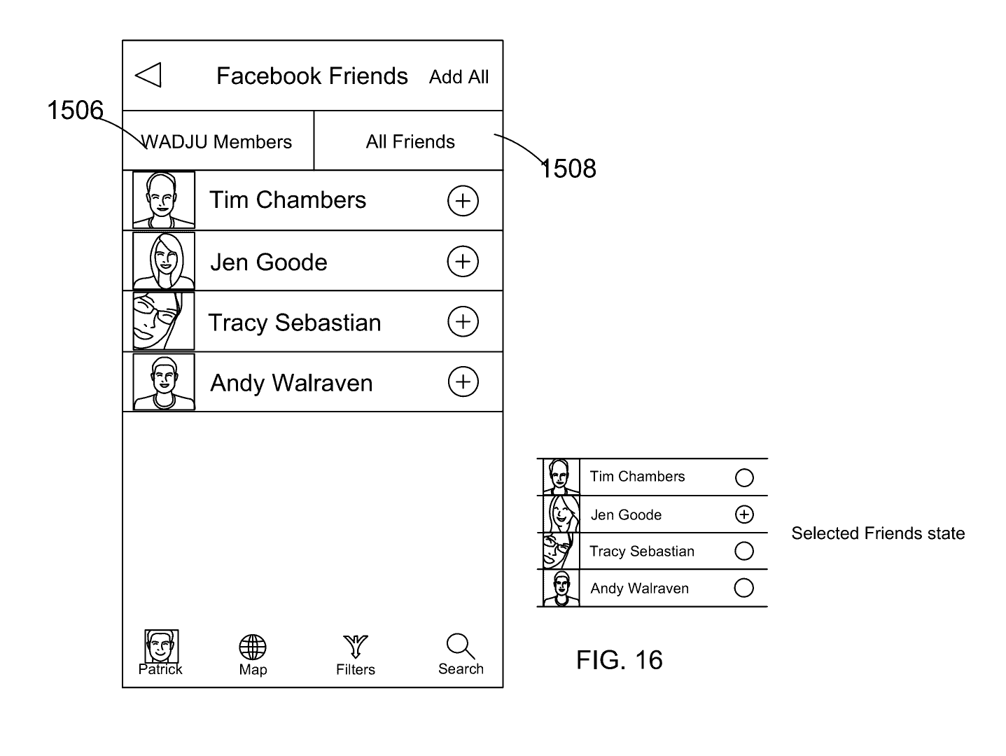

FIG. 16 is an example GUI showing Select/Invite, where after membership and upon granted permission, the application will download the contacts from a members mobile phone and determine if any of the contacts are already members of the application. Similarly, when a member joins the application, the application will determine which of the members social media such as facebook friends, or other such social media accounts, are already members of the application. The member will be informed of those contacts and facebook friends that are members of the application and the member will be provided with the ability to add their names to a category of members with whom the member is familiar. The member can add recognized members 1506 to their familiar list on an individual basis or all at once. For those contacts provided by the mobile phone that are not members 1508 of the application, the member will be permitted to contact them and notify them of member's membership with the application and invite these contacts to join the application.

In accordance with some examples of the invention, the application can allow a registered member to input the names of individuals from the contacts lists within their mobile telephone or other contacts list and determine which of said contacts are members of the application. These discovered members can then be added to a members friends list within the application. Further, the application can, if permitted, send notifications via text or email to those contacts that are not yet members to invite them to join.

In accordance with some examples of the invention, the application can allow a member to review the list of the member's friends that are members 1506 of the application. From that list, the member can then create subgroups of these friends. The member can create as many subgroups as the member wants to. The member can name these subgroups and use them as filters for other functionalities within the application.

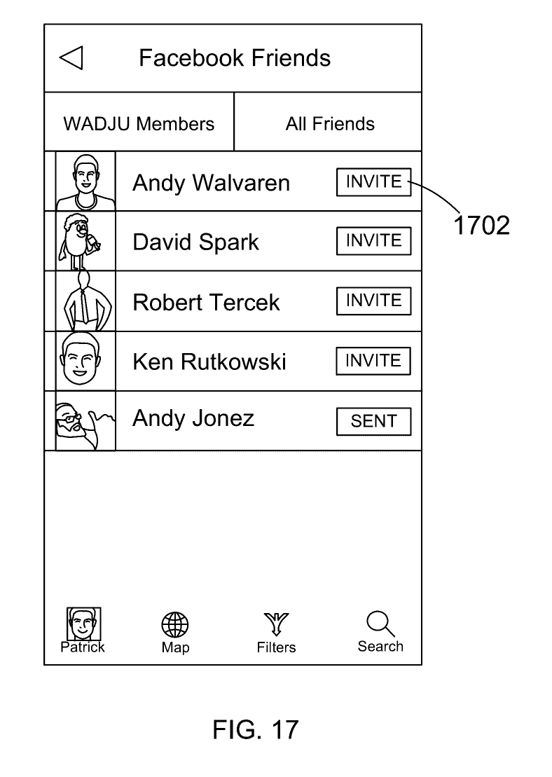

FIG. 17 is another example GUI showing Select/Invite, where the new member of the application may be given the ability and option to invite 1702 via email and/or text any of the contacts downloaded from the member's mobile phone who are not already members of the application. The invitation will state that the member is a member of the application and that the member is inviting the contact to try the application. The member can only send one invitation to a contact every week and the screen will indicate that an invitation has been sent to an individual contact.

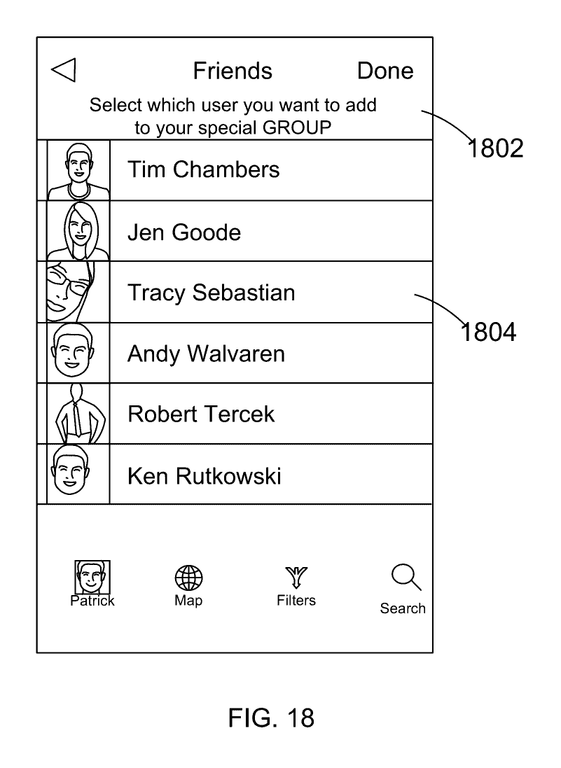

FIG. 18 is an example GUI showing a Subgroup Selection Mode 1802 where a member may evaluate the entire list of all application members 1804 with whom the member is familiar with and determine that the member would like to set smaller subgroups of that list. The member can select which individuals of the master list of members with whom the member is familiar with that will be included in the new subgroup. Member will name the group and it will be established as an applicable filter as applied by member.

### Filters Examples

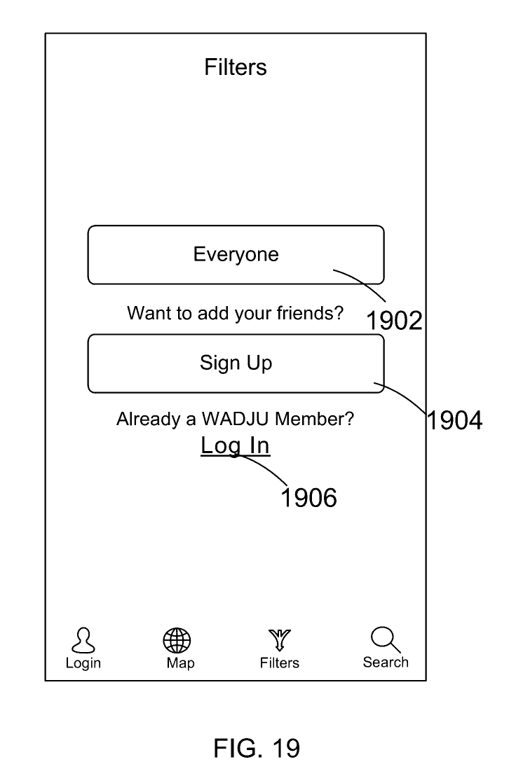

FIG. 19 is an example GUI showing filters, where non-member users may only be able to utilize the application using recommendation sources from all members of the application. As discussed above, a member user may have the option to apply filters to the information provided. One example filter is to show target information of identified friends of that particular user. Another example is to use the filters to create any number of groups from the list of members the member is friends with. The filters or subgroups created by the member, if any, may appear in alphabetical list form with a number beside them indicating how many members are a part of the subgroup. The member may select the filter or subgroup desired and that filter may then be applied to the recommendations and other information viewed by the member. In some examples, the only option available to Not Logged In users is to see everyone 1902. Tapping Sign Up takes the user to the SIGN UP/LOG IN screen 1904. Tapping Log In re-established the Facebook connection with the user and displays the appropriate FILTER page state for that User 1906.

### Settings Examples

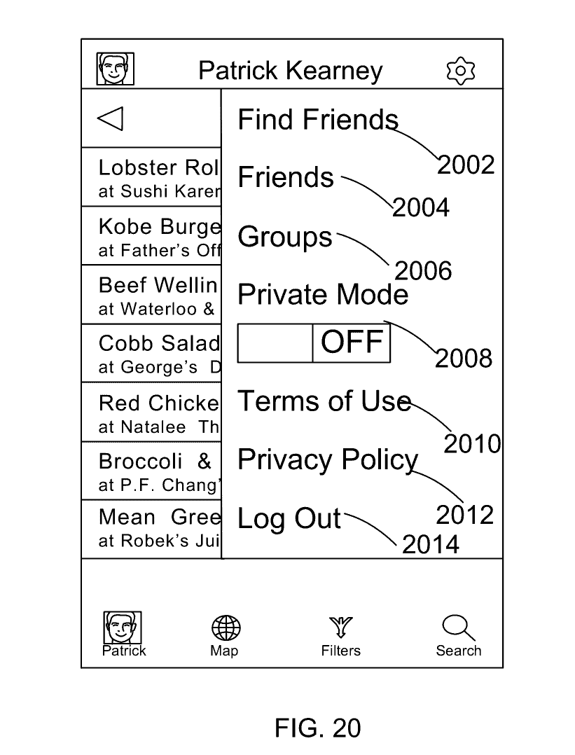

FIG. 20 is an example GUI showing Profiles settings, where a member may adjust and evaluate its personal recommendations page and review information about the application relevant to any member. The member may elect to go directly to the search mechanism 2002 for the application, may review the list of members 2004 with whom member is familiar, may review the groups 2006 that member has created from the master list of members with whom member is familiar, may set members election as to whether to keep member's personal recommendations page private or viewable to all 2008, may review the terms of use 2010 of the application, may review the privacy policy 2012 for the application or may log out of the application 2014.

### Groups Examples

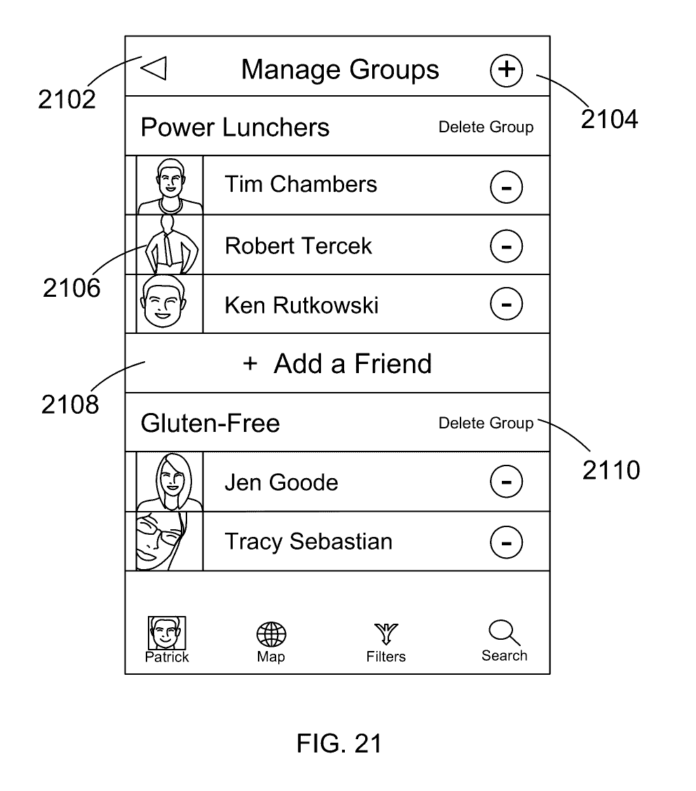

FIG. 21 is an example GUI showing Manage Groups, where a member may adjust the groups 2102 the member has made from the master list of all members that the member is familiar with. Member may create a new group 2104 and then indicate which members 2106 are to populate the group or member may add new members 2108 to already existing groups previously created, member may remove members from already existing groups or member may delete a group entirely 2110. Here, the user can manage all their Groups. They can add or remove people from the group, delete the group, or create a new group by tapping the plus sign in the upper right, tapping ADD A FRIEND 2108 takes the user to the FRIENDS (Selection Mode) screen for the Group creation process.

### Computer Components

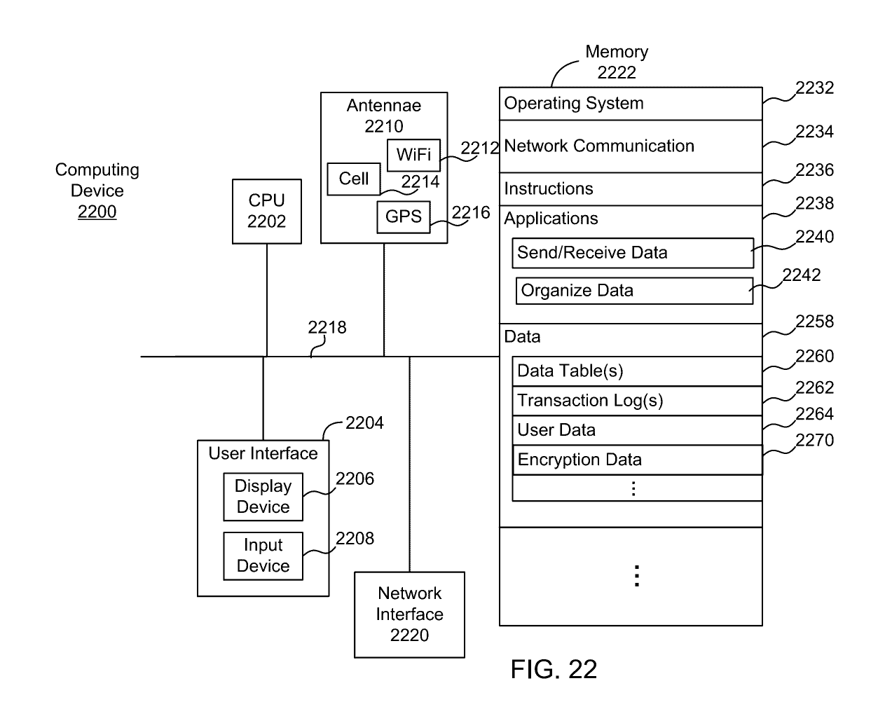

FIG. 22 shows an example computer which may be used to practice the methods and may be used as, or as a portion of the systems described here. The example includes a processor 2202 in communication with a bus 2218 or other communication pathway. Also included is a user interface 2202 which may include a display 2206 and an input 2208. The input could be any number of things including but not limited to touch screen, buttons, microphone, camera, gesture recognition, etc. Also included is an antennae 2210 which could be a WiFi 2212, cellular 2214 and/or GPS 2216 antenna. A network interface 2220 is shown as well, which could be any combination of network interfaces for the various network systems. A memory 2222 is also shown including running instructions to execute an operation system 2232 network communication 2234 instructions 2236 applications 2238 including sending/receiving data 2240 and organizing data 2242. Also shown are data storage 2258 including data tables 2260 transaction logs 2262 user data 2264 and encryption data 2270. Any number of other applications can be loaded into the computing device 2200.

### CONCLUSION

As disclosed herein, features consistent with the present inventions may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

The present invention can be embodied in the form of methods and apparatus for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The software is stored in a machine readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law. The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A non-transitory computer-readable storage medium comprising computer-executable instructions for networked collaboration, the computer-executable instructions comprising instructions for:
sending, from a mobile device in communication with a network and server over the network, login credentials from a first user;
sending GPS geographic coordinates of the mobile device to the server over the network;
receiving target information over the network, based on the geographic coordinates;
causing display of a subset of the target information;
causing display of a rating option of the target;
receiving a rating selection of the target;
sending the rating selection of the target to the server over the network; and
receiving a compiled rating of the target from the server over the network.

2. The non-transitory computer readable medium of claim 1, wherein the display of the rating option of the target includes at least one icon;
wherein the at least one icon display size is based on the received rating selection for the target.

3. The non-transitory computer readable medium of claim 2 wherein the received rating selection for the target rating is a touch screen swipe.

4. The non-transitory computer readable medium of claim 3 wherein the icon display size is based on the number touch screen swipes received.

5. The non-transitory computer readable medium of claim 4 wherein the icon is a heart.

6. The non-transitory computer readable medium of claim 4 wherein the icon is a circle with a bar through it.

7. The non-transitory computer readable medium of claim 1 further comprising instructions for:
causing display of an identity of a user who contributed to the rating of the target.

8. The non-transitory computer readable medium of claim 1 wherein the target information includes location information of the target.

9. The non-transitory computer readable medium of claim 8 further comprising instructions for:
causing display of a map including an indication of the target location and an indication of the mobile device location; and
causing display of a distance information between the target location and the mobile device location.

10. The non-transitory computer readable medium of claim 1 wherein the target is a restaurant and the target information includes restaurant information.

11. A system for networked collaboration, comprising:
a server in communication with a database and a network, the server configured to,
receive a login credential of a first user from a first mobile device over the network,
receive geographic coordinates from a GPS of the first mobile device of the first user over the network;
send information about a target to the first mobile device of the first user over the network, the target information based on the received geographic coordinates;
receive a rating of the target from the first mobile device of the first user over the network;
store the received rating of the target from the first mobile device of the first user;
receive a login credential of a second user from a second mobile device over the network,
receive geographic coordinates from a GPS of the second mobile device of the second user over the network; and
send the stored rating of the target to the second mobile device of the second user, if the received geographic coordinates from the second mobile device falls within a range from the target.

12. The system of claim 11 wherein stored rating of the target, sent to the second mobile device is capable of being displayed as an icon,
wherein the size of the displayed icon changes based on the rating.

13. The system of claim 11 wherein the server is further configured to,
provide a search capability to the first mobile device;
receive a search query from the first mobile device, the search query including target information;
send search results of targets based on the search query.

14. The system of claim 13 wherein the search query includes other user rating information.

15. The system of claim 11 wherein the server is further configured to, provide a filter capability to the first mobile device, the filter capability applying to the users submitting the stored ratings;
receive a filter criteria from the first mobile device over the network;
apply the filter criteria to the stored ratings; and
send a filtered set of stored ratings to the first mobile device over the network, the filtered set of stored ratings based on the applied filter criteria.

16. The system of claim 11 wherein the server is further configured to,
calculate a distance between the received location of the first mobile device to a known location of the target; and
send the distance to the first mobile device, for display on the first mobile device.

17. A method for networked collaboration, comprising:
by a server in communication with a database and a network,
receiving a login credential of a first user from a first mobile device over the network,
receiving geographic coordinates from a GPS of the first mobile device of the first user over the network;
sending information about a target to the first mobile device of the first user over the network, the target information based on the received geographic coordinates;
receiving a rating of the target from the first mobile device of the first user over the network;
storing the received rating of the target from the first mobile device of the first user;
receiving a login credential of a second user from a second mobile device over the network,
receiving geographic coordinates from a GPS of the second mobile device of the second user over the network; and
sending the stored rating of the target to the second mobile device of the second user, if the received geographic coordinates from the second mobile device falls within a range from the target.

18. The method of claim 17 wherein stored rating of the target, sent to the second mobile device is capable of being displayed as an icon,
wherein the size of the displayed icon changes based on the rating.

19. The method of claim 17 further by a server in communication with a database and a network,
providing a search capability to the first mobile device;
receiving a search query from the first mobile device, the search query including target information;
sending search results of targets based on the search query.

20. The method of claim 17 further by a server in communication with a database and a network,
providing a filter capability to the first mobile device, the filter capability applying to the users submitting the stored ratings;
receiving a filter criteria from the first mobile device over the network;
applying the filter criteria to the stored ratings; and
sending a filtered set of stored ratings to the first mobile device over the network, the filtered set of stored ratings based on the applied filter criteria.
